(19) United States
(12) Patent Application Publication
(10) Pub. No.: US 2005/0070391 A1
(43) Pub. Date: Mar. 31, 2005

(54) Hydraulic torque vectoring differential

(75) Inventors: Lawrence R. Folsom, Rensselaer, NY (US); Cliye Tucker, Lenox, MA (US)

Correspondence Address: J. Michael Neary;Neary Law Office, 542 SW 298th Street, Federal Way, WA, 98023, US

(73) Assignee: Folsom Technologies, Inc.

(21) Appl. No.: 10/990,041

(22) Filed: Nov. 16, 2004

Related U.S. Application Data
(63) Continuation-in-part of application No. PCT/US03/17919, filed on May 20, 2003.
(60) Provisional application No. 60/382,130, filed on May 20, 2002.
(60) Provisional application No. 60/458,664, filed on Mar. 29, 2003.

(51) Int. Cl. B62D 11/06

(52) U.S. Cl. 475/23

(57) ABSTRACT

A hydraulic torque vectoring differential includes two epicyclic gear sets and two variable displacement hydrostatic units. Each hydrostatic unit is coupled to a reaction member of one of each of the epicyclic gear sets, each of which also has a first gear element coupled to an input drive shaft for power input from a prime mover of said vehicle and a third gear element coupled to an output shaft operatively driving the wheels of the vehicle. The hydrostatic units are hydraulically coupled so that hydraulic fluid pressurized in one hydrostatic unit drives the other hydrostatic unit, and fluid pressurized in the other hydrostatic unit drives the one hydrostatic unit. A control system controls the displacement of the variable displacement hydrostatic units. Power from the prime mover flows primarily through the epicyclic gear sets to the output shafts, and only differential power is passed through the hydrostatic units, thereby isolating the hydraulic units from the primary power flow and making use of low displacement hydrostatic units possible for said differential power flow through said differential. The desired torque distribution between the two wheels is determined by existing conventional computer controls based on inputs from known traction sensors.

This is a continuation-in-part of International Application No. PCT/US2003/017919 filed on May 20, 2003 and published as International Publication No. WO 2004/005754 A2 on Jan. 15, 2004, which claims the benefit of U.S. Provisional Application No. 60/382,130 filed on May 20, 2002 and entitled “Hydraulic Torque Biasing Differential”, and of U.S. Provisional Application No. 60/458,664 filed on Mar. 29, 2003 and entitled “Hydro-Mechanical Torque Vectoring Differential”.

This invention relates to differentials in vehicle drive trains, and more particularly to a hydraulic torque vectoring differential capable of vectoring torque from the vehicle transmission at any desired ratio to any drive wheel.

### BACKGROUND OF THE INVENTION

A torque biasing differential powers both drive wheels in conditions where one wheel could slip and lose traction. An ordinary open differential, standard on most vehicles, can lose traction by spinning one wheel during acceleration or cornering because the open differential shifts power to the wheel with less grip. A torque biasing differential system, however, is designed to sense which wheel has the better grip, and biases the power to that wheel, while maintaining some lesser power to the other wheel.

During straight forward acceleration, torque biasing differential can produce close to ideal 50/50 power split to both drive wheels, resulting in improved traction over a conventional open differential. In cornering, while accelerating out of a turn, a torque biasing differential can bias engine power to the outside wheel, minimizing or eliminating spinning of the inside wheel, thereby allowing earlier acceleration in the curve and exiting the corner at a higher speed.

A torque biasing differential used in an all-wheel-drive configuration can control loss of traction when the front wheels are on slippery surfaces such as ice and snow or mud, providing the appropriate biased traction needed to overcome these adverse conditions.

Limited slip differential designs are an improvement over open differentials, but they use friction pads or plates that are prone to wear. Gear operated designs exist that are inexpensive and durable, but are not amenable to external controls that can achieve the optimal benefit from a fully controllable torque biasing differential.

### SUMMARY OF THE INVENTION

This invention provides a hydro-mechanical torque vectoring differential that is efficient, durable, and fully controllable.

The hydro-mechanical torque vectoring differential according to this invention includes an input bevel gear driving a transverse shaft from the vehicle drive shaft. The opposite ends of the transverse shaft are each coupled to and drive a ring gear of a epicyclic gear set, each having a planet carrier coupled to a respective right or left hand wheel axle, and each having a sun gear meshing with a torque plate of a respective right or left hand variable-displacement rotating bent-axis hydrostatic units hydraulically coupled through a center manifold.

The differential can operate in normal driving by setting the displacement of both hydrostatic units equal, and torque biasing can be achieved by differential displacement of the two hydrostatic units, wherein the precise distribution of torque between the two wheels is determined by the relative displacement of the two hydrostatic units. The desired torque distribution between the two wheels is determined by existing conventional computer controls based on inputs from sensors already known for vehicles to detect incipient loss of wheel traction. The only power transmitted through the hydrostatic units is differential wheel speed power, thereby keeping the size and weight of the hydrostatic units to a minimum, while increasing the life of the hydrostatic units due to their reduced duty cycle. As the hydraulic units see only differential wheel speed power, the parasitic losses of the differential will be very low when compared to a limited slip or torque-biasing differential that uses conventional clutches and brakes, as the clutches and brakes are slipping or freewheeling when the differential is in normal ‘open’ mode. As the torque biasing and locking features are actuated by hydraulic units as opposed to the use of conventional clutches and brakes (as in competing technologies) the life of the torque biasing units will be much longer as there are no wearing parts. There will also be no contamination of the differential oil due to wearing particles, as is the case of differentials that use clutches and brakes.

The response time of the differential can be made very fast (on the order of 60ms or less) by keeping the system pressure relatively high. A high system pressure can be maintained by continually stroking the hydrostatic units to a small enough displacement so that the reaction torque on the hydrostatic units will generate a relatively high pressure (in the region of 2000 psi) for any given torque throughput, thereby assuring that there is always enough control force to give a very fast response time.

System pressure could be measured with a sensor, or it is also possible to calculate the system pressure by measuring input speed, output speed and throttle position and then comparing these values against a look up table in the computer, and then stoking the hydrostatic units to a corresponding displacement, all at very high speed.

### DESCRIPTION OF THE DRAWINGS

FIG. 1 is a schematic diagram of a hydraulic torque vectoring differential in accordance with this invention, showing the straight ahead condition in which both wheels are turning at the same speed;

FIG. 2 is a schematic diagram of the hydraulic torque vectoring differential shown in FIG. 1, showing the cornering condition in which the inside wheel is turning at a slower speed than the outside wheel;

FIG. 3 is a schematic diagram of the hydraulic torque vectoring differential shown in FIG. 1, showing the full torque biasing condition in one wheel has no traction (on ice or off the ground) and full engine torque is being delivered to the other wheel;

FIG. 4 is a schematic diagram of the hydraulic torque vectoring differential shown in FIG. 1, showing the differential overspeed mode in which one wheel (the left hand wheel in this example) is driven to a higher speed than the other wheel;

FIG. 5 is a schematic diagram of the hydraulic torque vectoring differential shown in FIG. 1, showing the differential in fully locked differential mode, with both driven wheels locked together;

FIG. 6 is a schematic diagram of the hydraulic torque vectoring differential shown in FIG. 1 with a hydraulic control system for the hydrostatic units,

FIG. 7 is a schematic diagram of the hydraulic torque-vectoring differential in accordance with the invention, configured as a center differential;

FIG. 8 is a perspective view of a hydraulic torque vectoring differential in accordance with this invention;

FIG. 9 is a perspective view from below the hydraulic torque vectoring differential shown in FIG. 8;

FIG. 10 is a sectional elevation along the axis of the transverse driven output shafts of the differential shown in FIG. 8;

FIG. 11 is a sectional elevation along lines 11-11 in FIG. 12;

FIG. 12 is a sectional view along lines 12-12 in FIG. 11;

FIG. 13 is a perspective view from above of the coupled hydraulic units and control cylinder shown in FIG. 9;

FIG. 14 is a sectional elevation through the center of the apparatus shown in FIG. 13;

FIG. 15 is an end elevation of the apparatus shown in FIG. 13;

FIG. 16 is a sectional elevation along lines 16-16 in FIG. 15; and

FIG. 17 is a sectional view through the coupled hydraulic units of an embodiment of a hydraulic torque vectoring differential in accordance with this invention using end caps instead of yokes to support the cylinder blocks of the hydraulic units.

### DESCRIPTION OF THE PREFERRED EMBODIMENT

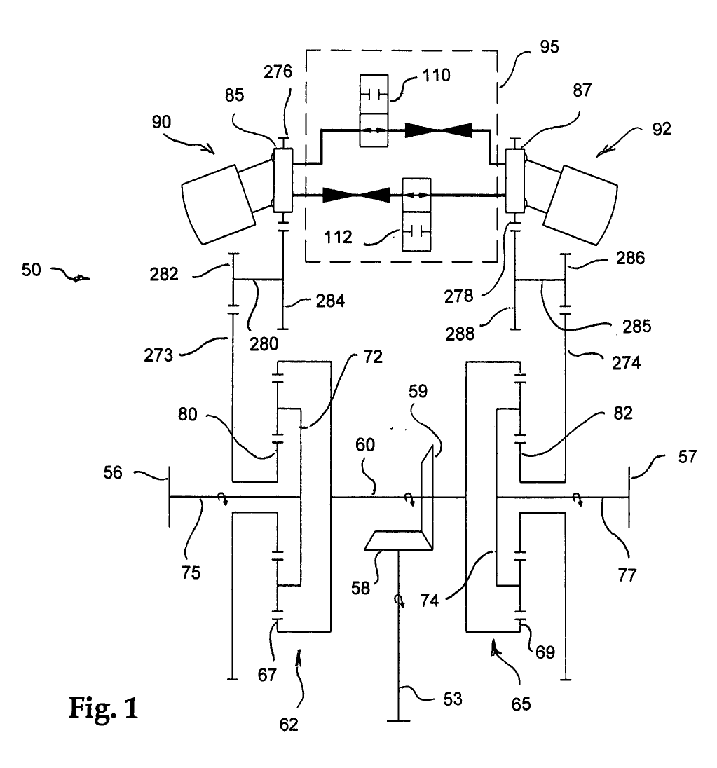

Turning now to the drawings, wherein like reference numerals designated identical or corresponding parts, and more particularly to FIG. 1 thereof, a hydraulic torque vectoring differential 50 is shown schematically, coupling a vehicle drive shaft 53 to right and left wheels 56, 57. An input bevel gear 58 on the input drive shaft 53 drives a driven bevel gear 59 on a transverse shaft 60.

The opposite ends of the transverse shaft 60 are each coupled to and drive a ring gear 67, 69 of right and left epicyclic gear sets 62, 65, respectively. Each epicyclic gear set 62, 65 has a planet carrier 72, 74, respectively, coupled to a respective right or left hand wheel axle 75, 77, respectively, and each epicyclic gear set 62, 65 has a sun gear 80, 82 meshing with a torque plate 85, 87 of respective right and left rotating bent-axis hydrostatic units 90, 92 hydraulically coupled together through a center manifold 95 and mechanically coupled through the epicyclic gear sets 62, 65 and the transverse shaft 60.

The differential 50 can operate in normal driving like a conventional open differential by setting the displacement of both hydrostatic units 90, 92 equal. The differential 50 can achieve torque biasing by differential displacement of the two hydrostatic units 90, 92, wherein the precise distribution of torque between the two wheels 56, 57 is determined by the relative displacement of the two hydrostatic units 90, 92. The desired torque distribution between the two wheels is determined by existing conventional computer controls based on inputs from sensors already used on vehicles to detect incipient loss of wheel traction.

In operation during straight-ahead travel, as indicated in FIG. 1, both hydrostatic units 90, 92 are adjusted to the same displacement. This may be maximum displacement or some fraction of maximum displacement, depending on control strategy. Input torque to both the right and left planet sets 72, 74 exerts a clockwise torque on the two hydrostatic units 90, 92 of equal magnitude. Flow from each hydrostatic unit 90, 92 is dead-headed against the other, locking the hydrostatic units against rotation, hence locking the sun gears 80, 82 to which they are engaged against rotation. Therefore, each wheel 56, 57 rotates at the same speed as the other, and with the same torque.

The benefit to having both units at maximum displacement under straight ahead conditions is that it reduces the operating pressure of the hydrostatic units 90, 92 for any given input torque. To activate torque vectoring, there just needs to be a difference in displacement; there is no need to increase one as the other decreases in displacement. However, there may be an advantage of keeping both hydrostatic units 90, 92 at some displacement smaller than maximum: one can be stroked towards maximum displacement and simultaneously stroking the other towards minimum displacement and therefore theoretically halve the time it takes to achieve a given displacement difference.

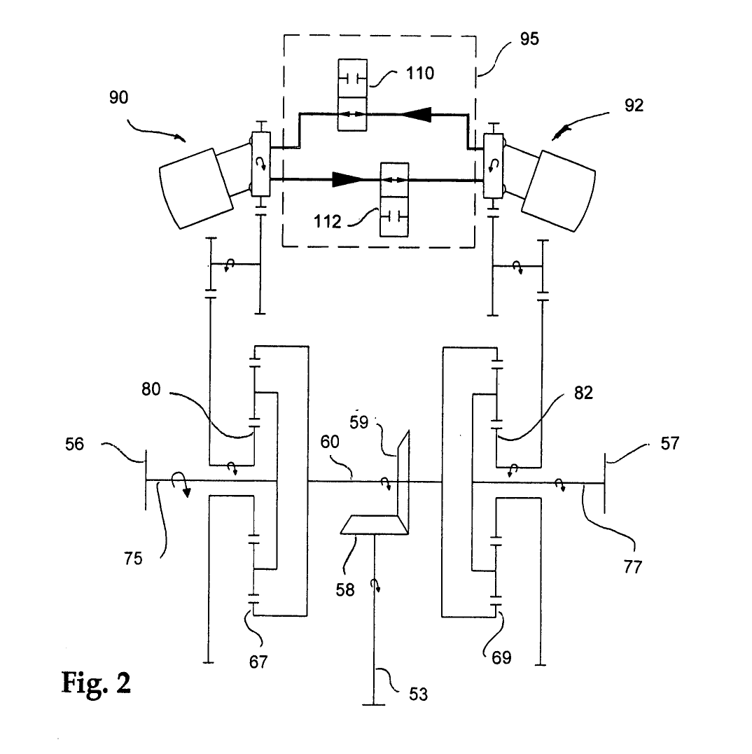

During cornering, the outside wheel (the right wheel 56 in the example shown in FIG. 2) increases in speed relative to the left wheel 57. This has the effect of rotating the left sun gear 82 in a clockwise direction, and hence rotating the left hydrostatic unit 92 in a counterclockwise direction and allowing fluid flow from the right hydrostatic unit 90 so that it can rotate at the same speed as left hydrostatic unit 92, but in the opposite direction. The effect is a slowing of the left wheel 57 by the same amount as the increase in speed of the right wheel 56.

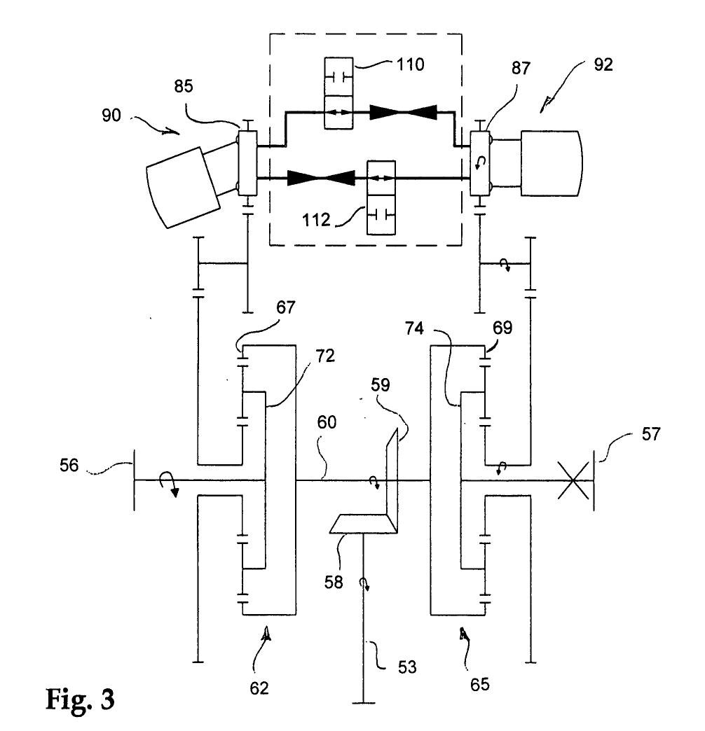

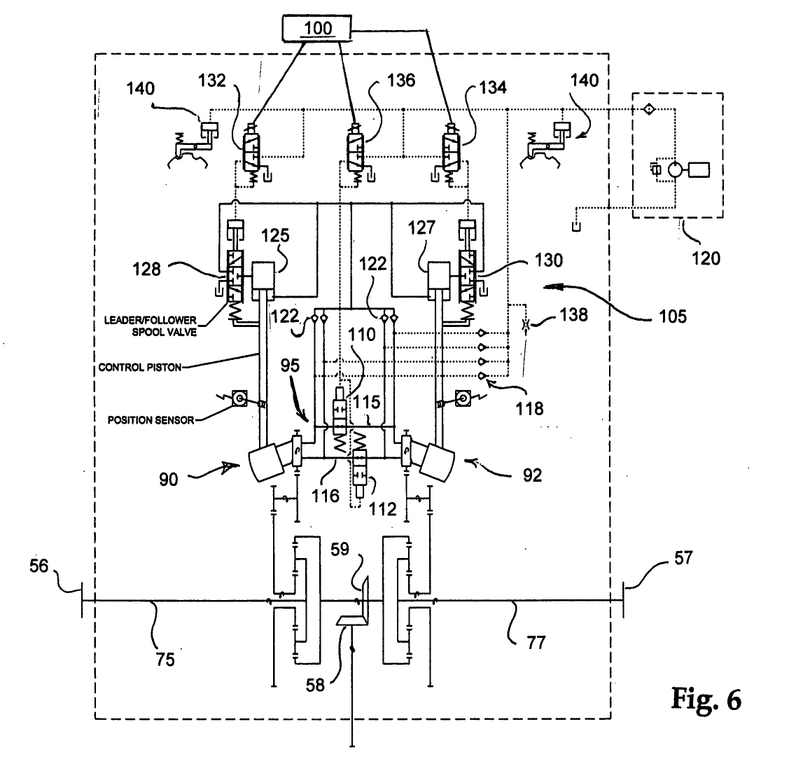

When one wheel loses traction (the right wheel 56 as illustrated in FIG. 3), as when it is on ice or off the ground, a conventional vehicle traction control system 100 (shown in FIG. 6) detects the loss or incipient loss of traction of the wheel 56 by means of conventional sensors known in the vehicle control art, and sends a signal to a displacement control system 105 (shown in detail in FIG. 6) for the hydrostatic units 90 and 92 to stroke the left hydrostatic unit 92 to full displacement and the right hydrostatic unit 90 to zero displacement. Full control movement of the hydrostatic units 90, 92 can be performed in about 40-50 milliseconds. Examples of leader-follower displacement controls usable in this application can be found in U.S. Pat. Nos. 6,530,855 and 6,358,174, and in PCT International Publication No. WO 01/98659 published on Dec. 27, 2001, the disclosure of which is incorporated herein by reference. At zero displacement, the right hydrostatic unit 90 can no longer react any torque, so the sun gear 80 can freewheel and no torque is transferred to the right wheel. At full displacement, the left hydrostatic unit cannot rotate because there is nowhere for the fluid to go, coupled as it is to the right hydrostatic unit at zero displacement. This has the effect of locking the right sun gear 82, so full torque is sent to the left wheel 57.

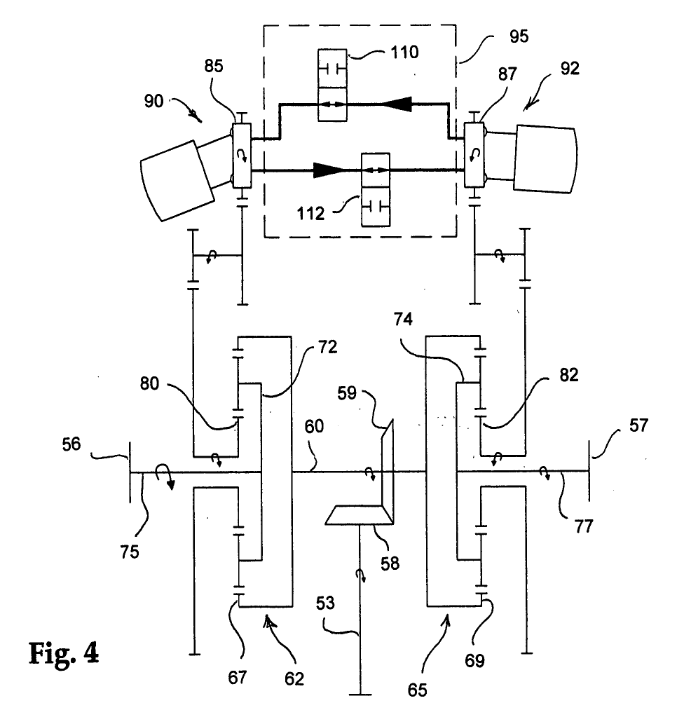

With increased acceleration through a turn, weight shifts to the outside wheel (wheel 57 in the example illustrated in FIG. 4), and the traction on the inside wheel 56 can drop below that needed to support the torque load. Before the wheel begins to slip, the vehicle sensors detect an incipient loss of traction and sends a signal to the vehicle traction control system 100 (shown in FIG. 6). The control system 100 sends a signal to the displacement control 105 to effect a displacement difference between the left and right hydrostatic units 90, 92. As both hydrostatic units 90, 92 are hydraulically connected to each other, they will both be subjected to the same high pressure, this pressure being dependant on the amount of torque being reacted and displacements of the hydrostatic units. When the right hydrostatic unit 92 is at a smaller displacement than the left hydrostatic unit 90, it will react less torque than the left hydrostatic unit 90 for any given pressure, therefore there will be less torque transmitted to the right planet set 65 and to the right output shaft 57 than there will be through the left planet set 62 and left output shaft 56. Due to the fact that there is a torque bias toward wheel 57 than there is toward wheel 56, wheel 57 will try to turn faster than wheel 56, causing a directional change to the vehicle. As wheel 57 increases in speed, the hydrostatic unit 90 rotates in a clockwise direction causing fluid flow, this fluid flow then causes the hydrostatic unit 92 to rotate in the opposite direction at a rate proportional to the relative displacements between the hydrostatic units 90 and 92, which has the effect of slowing the right wheel 57. The amount of torque biasing between the left and right wheel being directly proportional to the relative displacements of the hydrostatic units 90 and 92. The amount of speed difference between the left and right wheel being dependant upon the vehicle dynamics being affected by the torque bias.

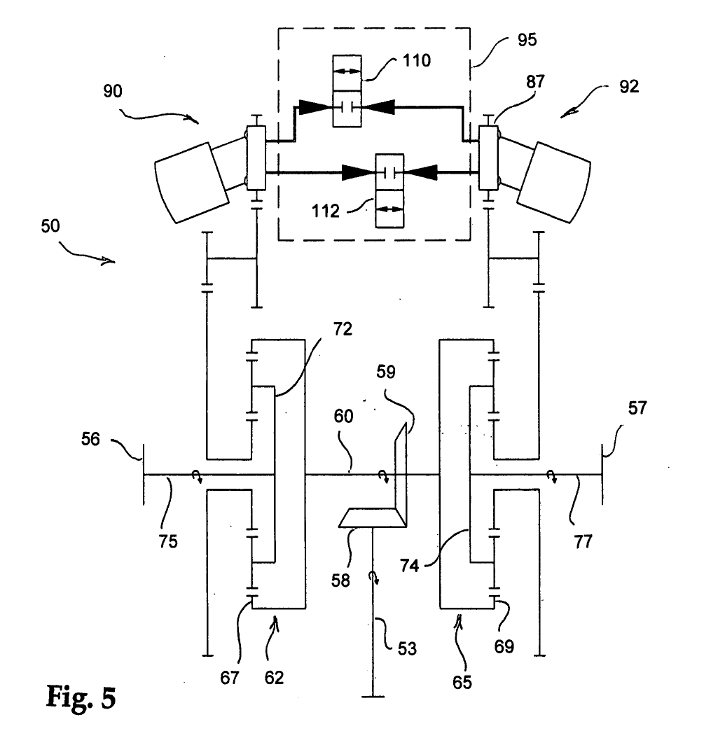

When extreme conditions are encountered, such as in off road driving conditions, it may be preferable to have both driven wheels locked together in a fully locked differential mode, as illustrated in FIG. 5. To achieve this there is a valve xx that, when activated by the control system, will block both the high and low pressure flow to and from the hydrostatic units 90, 92, thereby stopping both hydrostatic unit's from rotating, and therefore locking both sun gears. The valve can be modulated to slow the rotation of the hydrostatic units as well as lock the hydrostatic units, therefore giving the operating mode of a limited slip differential.

The locking or limited slip differential mode can also be used to cause some overspeed functioning when going around a corner. When cornering, the inside wheel slows down whilst the outside wheel speeds up. Activating the lock valve will causing the differential to approach a locked differential thereby causing the wheels to approach the same speeds. This will have the effect of speeding up the inside wheel whilst slowing the outside wheel.

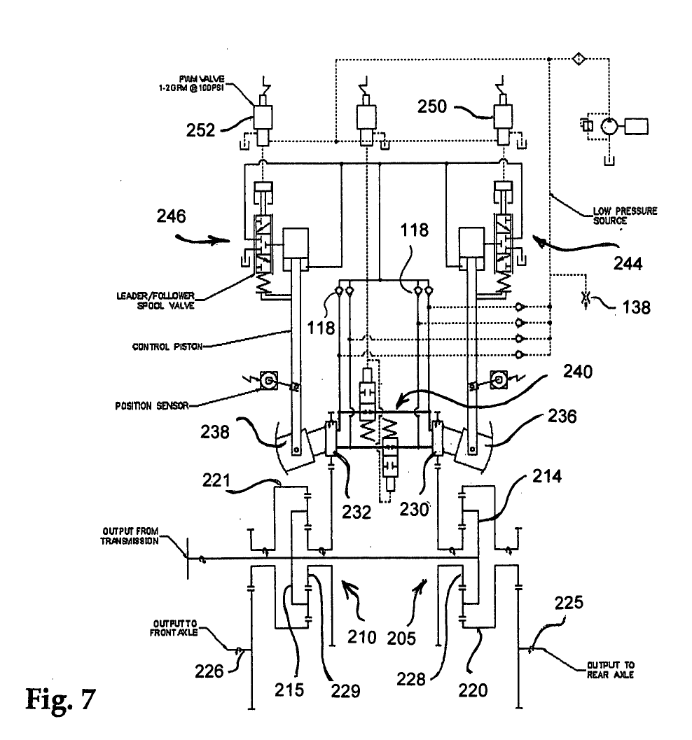

One primary benefit of the arrangement of epicyclic geartrains with hydrostatic units, shown in FIGS. 1-6, and also shown in FIG. 7 discussed below, is that the geartrain carries the main power flow through the differential, and the hydraulics are isolated from the main power flow. The only power that is passed through the hydrostatic units is just the differential power as when cornering (as one wheel goes faster when cornering), which is very low. This makes the use of hydraulics feasible in this application and also makes the use of low displacement hydrostatic units possible. For example, in a torque vectoring differential, it is possible to use two hydrostatic units having a small displacement of only 3.5 in³, whereas in a continuously variable hydro-mechanical power transmission of the same power, two hydrostatic units, each having a displacement of about 15 in³, are used.

As shown in FIG. 6, the right and left hydrostatic units 90, 92 are hydraulically connected through the stationary manifold 95 such that when both hydrostatic units are rotated in the same direction they will both discharge fluid to the same port, thereby causing both hydrostatic units to dead head against each other. This will cause both hydrostatic units to be locked when turned in the same direction, but allow free flow from one hydrostatic unit to the other when they are turned in opposite directions.

Lock valves 110 and 112 are placed in the fluid flow lines 115, 116 between the two hydrostatic units 90, 92 such that the flow (both pressure and suction) from one hydrostatic unit to the other passes through the lock valves 110, 112 when open. The lock valves are normally held open (by a spring for example) so that they allow free flow from one hydrostatic unit to the other. The lock valves 110, 122 can be signaled (by an external pilot pressure source controlled by an electrically controlled valve 136, for example) to close so that no fluid can flow from one hydrostatic unit to the other, regardless of hydrostatic unit rotation direction. Therefore, when the lock valves are activated, the hydrostatic units and hence the planet set reaction member are held stationary, hence causing both the right and left output speeds to be equal. The differential will now act as a locked differential.

Four check valves 118, one each placed at either side of the lock valves 110, 112, allow hydraulic fluid at makeup pressure from a make-up pressure source 120 to enter the low pressure side of the hydrostatic unit flow (regardless of whether the lock valves are open or closed) to replenish any fluid that is lost from the hydrostatic units due to leakage.

Four other check valves 122, one each placed at either side of the lock valves 110, 112, tap off hydraulic fluid from the high pressure side of the hydrostatic unit flow circuit, regardless of whether the lock valves 110, 112 are open or closed, to feed to a control circuit, to be described below. This pressure is fed continually to the small side of right and left displacement control cylinders 125 and 127, and fed via two modulating valves 128 and 130 to the large side of the left and right control cylinders 125, 127.

In the case shown make up pressure is fed to three conventional electro-proportional valves 132, 134 and 136 that regulate the make up pressure supplied from the source 120 down to a signal pressure according to an electronic input signal from the vehicle traction control 100. The signal pressure from electro-proportional valves 132, 134 is used to control the modulating valves 128, 130, respectively, for the left and right hydrostatic units 90, 92. The electro-proportional valve 136 activates or modulates the lock valves 110, 112. Since the lock valves 110, 112 are controlled by an electro-proportional valve, it is possible to modulate the amount of flow blocking that the valves 110, 112 effect, and thereby limit the locking of the differential, creating a limited slip differential.

Hydraulic fluid at make-up pressure is fed via an orifice 138 to a lubrication circuit that supplies lubrication and cooling oil to the necessary gears shafts and bearings etc.

A locking function may be provided in this differential by two parking pawl mechanisms 140, one each connected to the reaction member of the right and left planet sets. The parking pawls are held in an unlocked position by a hydraulic actuator that is connected directly to the makeup pressure that overcomes a spring force on the pawl. In the absence of makeup pressure the spring force retracts the actuator and engages the pawl such that it locks the reaction member to ground. This will have the effect of locking the differential when the makeup pressure is turned off, so that if the vehicle is parked over a period of time using the automatic transmission parking pawl, the driven wheels can not rotate as the hydrostatic units leak down.

Turning now to FIG. 7, a torque vectoring differential 200 is shown in schematic form configured as a center differential/transfer case. It has the same operation as the axle differential illustrated in FIGS. 1-4, except that it vectors torque to the front and rear differentials as opposed to the right and left wheels. The planetary gear trains 205 and 210 are similar to the planetary gear trains 62, 65 in FIGS. 1-4, although the planet set arrangement is different to optimize the torque/speed paths through the geartrains. On the axle differential, shown in FIGS. 1-4, power is taken out from the planet gear carriers 72, 74, and power goes to the hydrostatic units 90, 92 via the sun gears 80, 82, giving the highest possible speed ratio between the high output torque and the hydrostatic units. In the center differential, the input power is via planet gear carriers 214,215, since the input and output torques are the same. Since the output speed from ring gears 220, 221 is higher than the input speed into the carrier, a gear ratio between the ring gears and the forward/rear output shafts 225, 226 is used to bring these shaft speeds back to input speed.

The geartrain arrangements are different in the axle differential and the center differential because, in an axle application, a torque multiplication is desired from input to output. Hence, the highest torque reduction from the output to the hydrostatic units is preferred. In a center differential application, no torque multiplication is normally desired between output and input, and generally output torque (to the front and rear) will be less than the input because it is split between these two outputs. Therefore, the highest torque reduction from the input to the hydrostatic units is a benefit.

Sun gears 228 and 229 are coupled to torque plates 230 and 232 of two variable displacement hydrostatic units 236 and 238, which are hydraulically coupled through a stationary center manifold 240 in fluid communication with the two rotating torque plates 230, 232. Torque distribution between the output to the front axle and the output to the rear axle is governed by the relative displacement of the two hydrostatic units 230 and 232, as noted above. The displacement of the two hydrostatic units 236, 238 is controlled by two controllers 244 and 246. The controllers 244,246 in turn are controlled by valves 250 and 252 which operate in response to electrical signals from the vehicle traction control system 100 (shown only in FIG. 6).

A vehicle with a torque vectoring center differential, under certain cornering conditions, will behave better than an all-wheel-drive car. Of course, a locking center differential has obvious benefits during low traction conditions.

There are benefits to using a hydraulic torque vectoring axle with a torque vectoring center differential, making it possible to send any desired proportion of the available power to any particular wheel, but the capability that this offers must be traded off against the extra cost, complexity and additional weight and slightly decreased efficiency, as is true with most technical improvements.

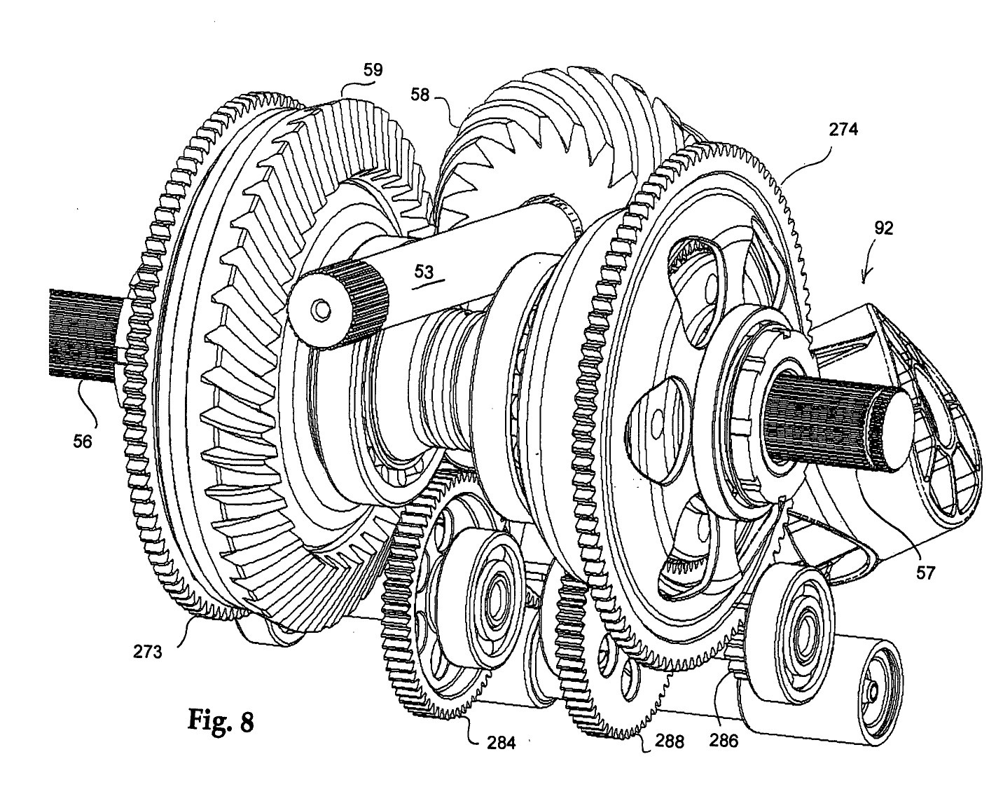

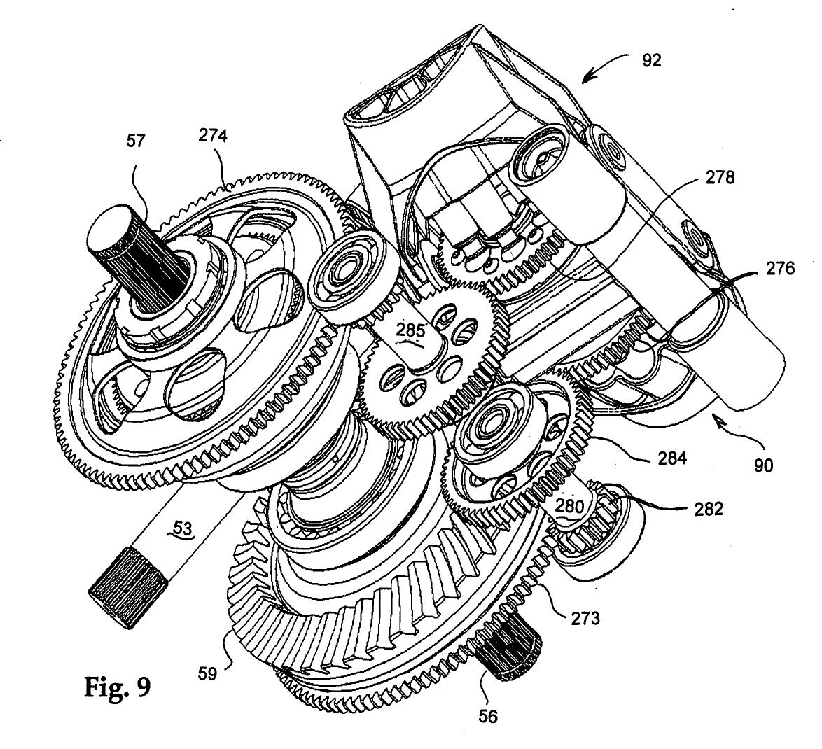

One particular embodiment of a torque vectoring differential, of the type shown schematically in FIGS. 1-6, is shown in FIGS. 8 and 9. The input drive shaft 53, driven from the vehicle's transmission, has the input bevel gear 58 attached to its rear end. The input bevel gear 58 (Bg1) is engaged with and drives the driven bevel gear 59 (Bg2) on the transverse shaft 60, shown in FIG. 10. The transverse shaft 60 has an enlarged bell-shaped right end with a radially protruding flange 260 on its exterior periphery, and the ring gear 67 on its inner surface. The driven bevel gear 59 is attached to the flange 260 to transfer input torque from the vehicle drive shaft 53 to the transverse shaft 60.

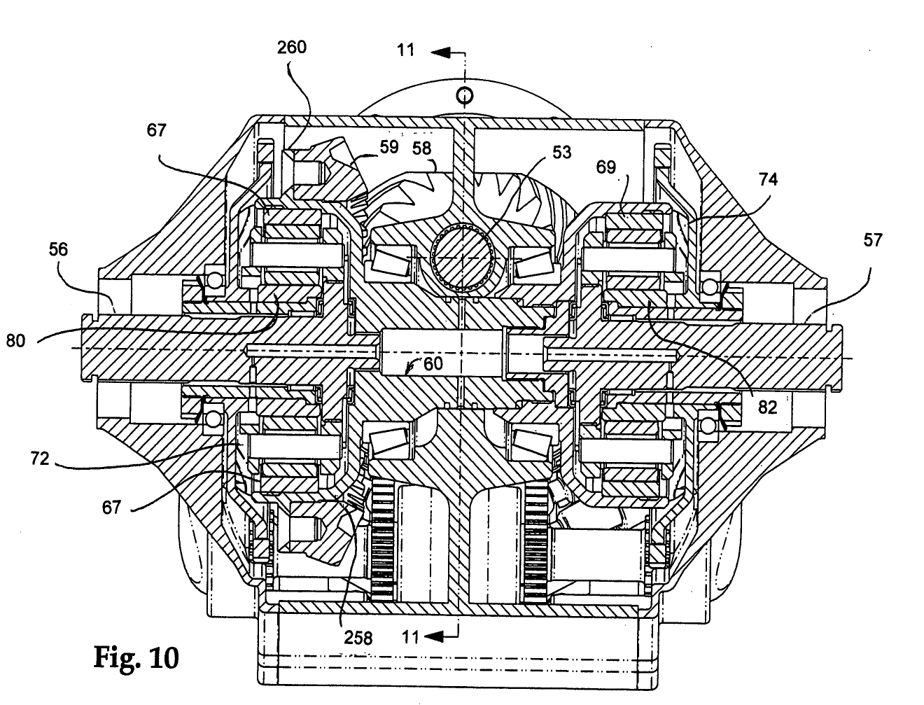

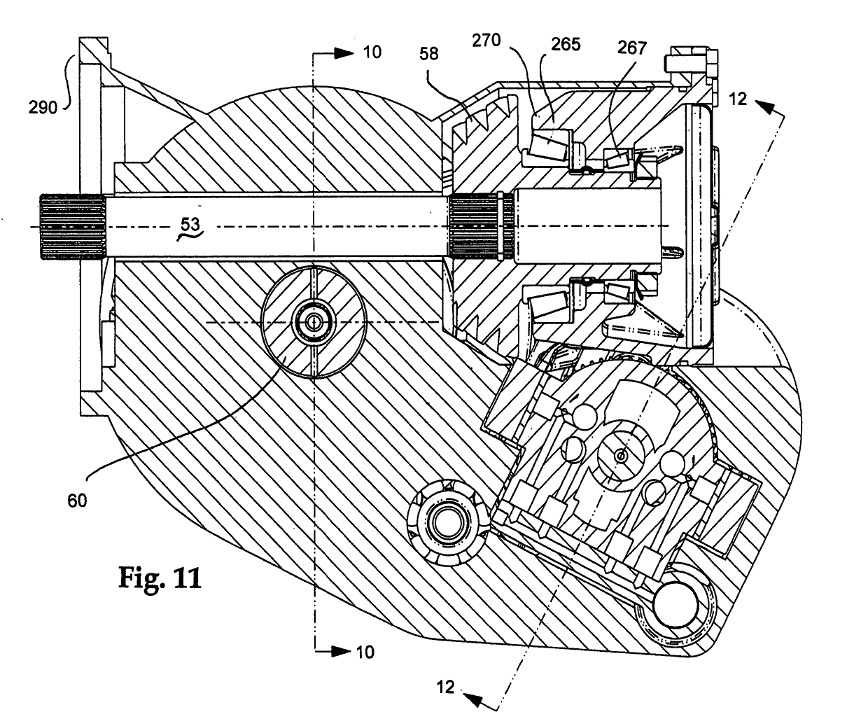

As shown in FIG. 11, the input drive shaft 53 is supported by two bearings 265 and 267 located in a bearing housing 270. The transverse shaft 60 is driven by the output bevel gear 59 (Bg1) and is connected drivingly to the input members of the of two planet sets. In the case shown, the input members of the right and left planet sets are the ring gears 67 and 69. The output member of the two planet sets—in the case shown this being the planet carriers 72, 74—are each connected to the right and left driving wheels 56, 57 of the vehicle, respectively. The reaction member of the planet sets, in this case, the sun gears 80, 82 (Sp) drive, through via gears 275, 277, the input members of a hydrostatic pump/motor, in this case, the torque plates 85 and 87.

Torque from the vehicle drive shaft is multiplied through the gears 58, 59 of the bevel gearset and then by the planet set ratio. Therefore the output torque of this embodiment of the differential is:
Output torque=Input torque×Bg1/Bg2×(1+(Sp/Rp))
This output torque is the total torque available to both wheels. The output torque available at the left wheel is:
Input torque×Bg1/Bg2×(1+(Sp/Rp))/(1+Rdsp/Ldsp)
Where Rdsp is the displacement of the right hydrostatic unit 90, and Ldsp is the displacement of the left hydrostatic unit 92.

The output torque available at the right wheel is:
Input torque×Bg1/Bg2×(1+(Sp/Rp))/(1+Ldsp/Rdsp)

As there is an additional torque multiplication from the planet set ratio, the bevel gear ratio (and hence its torque multiplication) is reduced by the amount of the planet set ratio in order to achieve the same overall differential ratio as is currently used.

It is advantageous to reduce the amount of torque multiplication through the bevel gear set as this not only reduces the size and weight of this gearset itself, but also reduces the loading induced into the housing and support bearings. Although there is an additional torque multiplication through the planet sets, they are much more efficient—in terms of size and weight—in multiplying torque than a bevel gearset as all of the induced loads are counteracted within the planet set itself. Therefore the structural requirements of the bevel gearset its support bearings and the housing can be reduced. This will help offset the additional weight and cost of the additional planet sets.

The speed of the planet set reaction members 80, 82 are relatively small, as it only rotates at a ratio of differential wheel speed, therefore the power transmitted to the hydrostatic units 90, 92 will also be relatively small compared to the differential input power.

It is desirable to keep the size and weight of the hydrostatic units 90, 92 as small and light as possible. In order to do this it is desirable to reduce the amount of torque the hydrostatic units 90, 92 must react, while still keeping the operating pressures within acceptable limits. Since the rotational speed of the planet set reaction members 80, 82 are relatively slow, it is possible to use a large gear ratio between these reaction members 80, 82 and the hydrostatic unit input members 85, 87, thereby reducing the reaction torque whilst still keeping the hydrostatic unit speeds to within acceptable limits. In the case shown this is achieved by having a large bull gear 273, 274 attached to the sun gears 80, 82, respectively, driving a spur gear 276, 278 attached to the input members 85, 87 of the hydrostatic units 90, 92. To improve the overall packaging and further increase the ratio between the sun gears 80, 82 and the hydrostatic units 90, 92, a lay shaft 280, 285 that uses a compound gear arrangement may be used. The compound gear arrangement for the lay shaft 280 has a small gear 282 driven by the bull gear 273 and a larger gear 284 driving the spur gear on the torque plate 85 of the right hydrostatic unit 90. The compound gear arrangement for the lay shaft 285 has a small gear 286 driven by the bull gear 274 and a larger gear 288 driving the spur gear 278 on the torque plate 87 of the left hydrostatic unit 92.

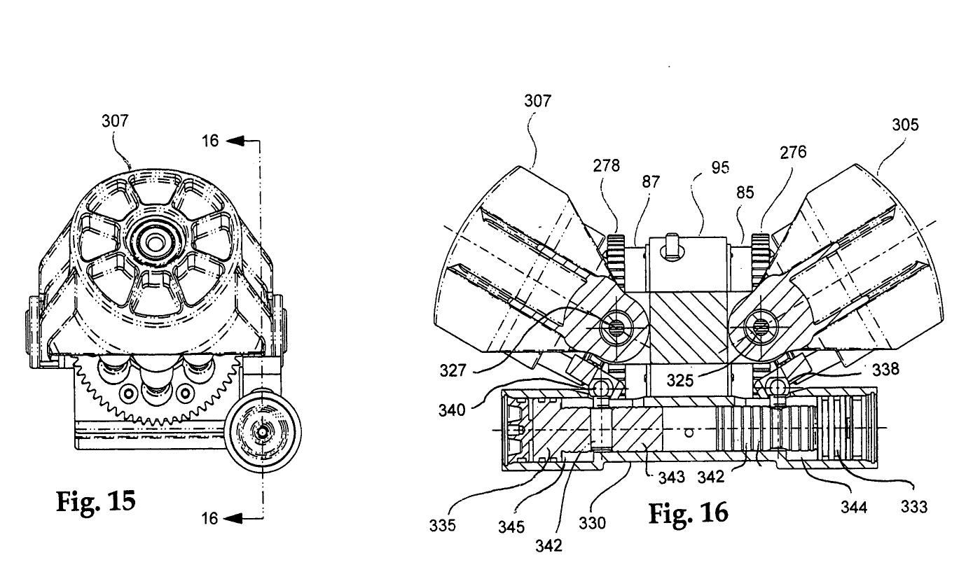

In the application illustrated in FIGS. 8-17, the vehicle has the prime mover in the front of the vehicle and the transmission and attached differential in the rear, for optimal weight distribution. In this application, it is desirable to reduce the distance between the differential mounting flange 290 and the centerline of the output shafts 56, 57. Therefore the input bevel gear 58 gear is placed behind the driven bevel gear 59 and mainshaft assembly 60. This places the support bearings 265. 267 for the input bevel gear 58 at the rear of the differential, as clearly shown in FIGS. 8 and 11.

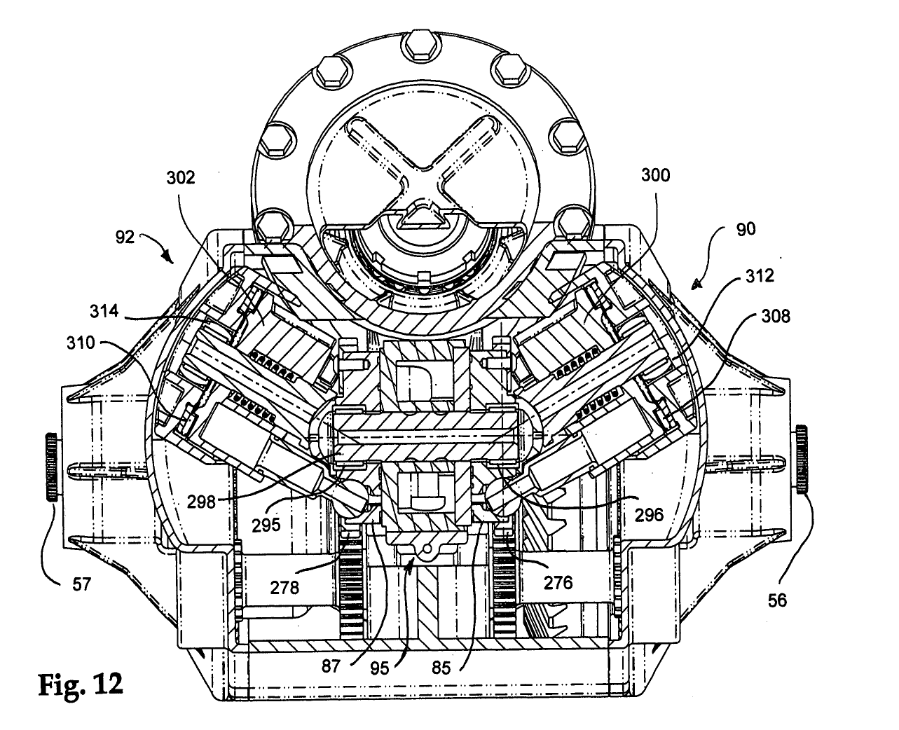

The hydrostatic assembly of right and left hydrostatic units 90, 92, shown in FIG. 12, is a series arrangement similar to that described in Pat. No. 6,358,174. The series arrangement of the two hydrostatic units 90, 92 on opposite sides of the manifold has the advantage of minimizing length of and simplifying the flow passages between the hydrostatic units, thereby reducing the flow losses, as well as reducing the number of components that have to have the integrity to contain this fluid flow.

In this application power is inputted to the hydrostatic unit via spur gears 276 and 278 that are attached to the outside of the torque plates 85 and 87, respectively, of the hydrostatic units 90, 92. As the power that is placed through these gears 276, 278 are relatively small (as stated previously) it is possible to use a standard straight cut spur gear, as opposed to a helical gear. This eliminates any axial forces from the spur gear that otherwise would need to be reacted through the torque plate interface with the manifold 95.

By careful orientation of the gear mesh between the spur gears 276, 278 and the gears 284, 288 with respect to the pivot axis of the hydrostatic unit, it is possible to use the gear mesh radial forces to counteract the hydrostatic unit radial forces placed upon the torque plates 85, 87 from the pistons of the hydrostatic units 90, 92, thereby reducing the resultant radial force induced on the torque plate. This reduces the size of the radial bearings 295, 296 required to support and locate the torque plates 87, 85 as well as reduce the amount of bending on the torque plate support shaft 298.

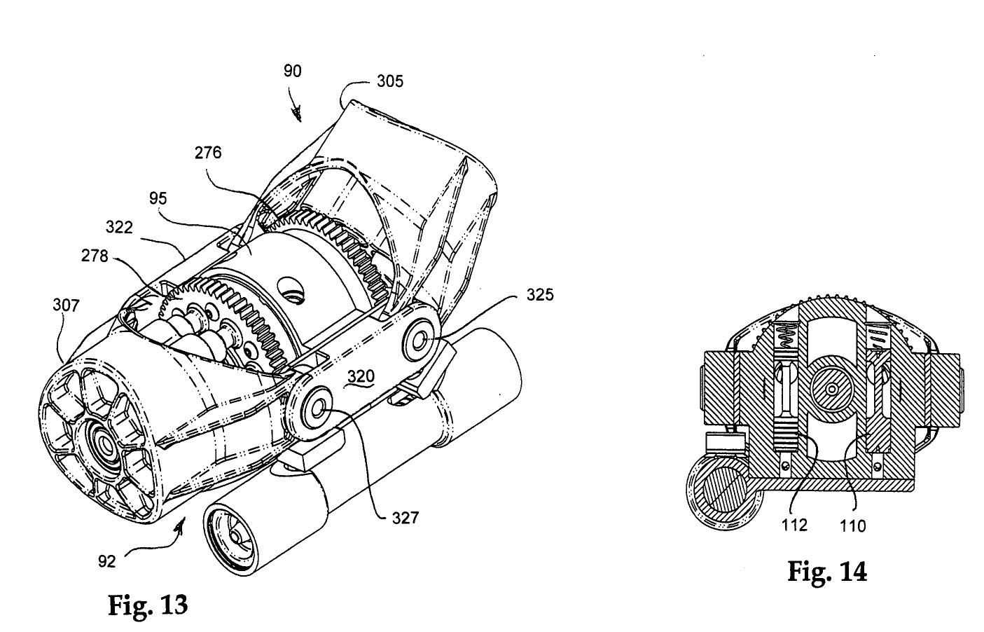

As shown in FIGS. 12 and 13, the right and left hydrostatic units 90, 92 are positioned on either side of the centrally located manifold 95. The manifold locates the hydrostatic unit support shaft 298 that in turn locates and supports the torque plates 85, 87 via radial bearings 296 295 on the support shaft 298. The flow between the left and right hydrostatic units 92, 90 passes through the manifold 95 by way of openings in the torque plates 85, 87 which open in sockets that receive the piston heads and are held in the sockets by a flange on the spur gears 276, 278.

As shown in FIG. 14, the manifold houses the two valves 110 and 112 that, when activated, block the flow between the left and right hydrostatic units 92, 90, thereby locking the hydrostatic units (and hence the planet set reaction member) from rotating and therefore creating a ‘locked differential’.

The manifold also contains the check valves 118 that allow make up fluid flow under make-up pressure from the unit 120 to replenish fluid lost from the hydrostatic units 90, 92 due to leakage, and also has the check valves 122 that tap off high pressure from the hydrostatic units for use in the hydrostatic unit displacement control 105. The manifold and hydrostatic unit assembly shown in FIG. 13 is rigidly mounted to the differential housing.

The hydrostatic subassembly including the right and left hydrostatic units 90, 92 hydraulically coupled through the manifold 95, shown in FIGS. 12 and 13, include two cylinder blocks 300, 302 supported by two tilting non-rotating yokes 305, 307 via an axial bearing 308, 310 and a radial bearing 312, 314. The yokes 305, 307 are attached to the manifold by two links 320, 322 via pin joints 325, 327 on the rear side, and two similar pin joints on the front side (not shown) that allow the yokes 305 to pivot with respect to the manifold 95. By tilting the yokes about their pivotal axis through the pin joints 325 and 327, the cylinder blocks 300, 302 are placed at an angle to the torque plates 85, 87 and causes the hydrostatic units to have some displacement. The yokes 305, 307 contain the axial forces from the cylinder blocks 300, 302. This axial force is then fed to the manifold through the link pins 325, 327 and links 320, 322 to counteract the axial force from the corresponding torque plate 85, 87. As both the right and left yokes are connected to the manifold through the same links, the axial force from the yokes 305, 307 is taken mainly in tension through the links 320, 322 and counteract each other. As the torque plates 85, 87 of both the right and left hydrostatic units 90, 92 are supported by the same manifold 95, the axial forces from the torque plates 85, 87 places the manifold mainly in compression and counteract each other. This gives an inherently strong and stiff structure, thereby reducing the size and weight of the supporting members. Both the radial and axial forces that are generated by the hydrostatic units 90, 92 are self-contained within the hydrostatic unit assembly, thereby eliminating any hydrostatic unit induced loads from being transmitted to the differential housing structure. This reduces the structural requirements and hence the size and weight of the differential housing. The only load that is transmitted from the hydrostatic unit assembly to the differential housing is the radial load induced from the mesh between the torque plate spur gears 276, 278 and the gear 284, 288.

The displacement control system 105, shown schematically in FIG. 6 and shown mechanically in FIGS. 13 and 16, includes the control cylinders 125, 127, which, in this case, are attached end-to-end in a single cylinder 330, and pistons 333, 335 that are used to vary the displacements of the right and left hydrostatic units 90, 92. The right and left hydrostatic unit yokes 305, 307 are connected to the control pistons 333, 335 via spherical pin joints 338, 340, using spherical pins 342 (only one of which is shown) rigidly mounted to the piston rods 342, 343 of the control pistons 333, 335. As the control pistons 333, 335 move in the control cylinder 330, the spherical pins causes the yokes 305, 307 to tilt about the pivotal axis and thereby change the displacements of the hydrostatic units 90, 92.

System pressure is tapped off from the manifold 95 via four check valves 122 (shown in FIG. 6) and is fed continually to the piston rod area 344, 345 of both control pistons 333, 335. The area of this annular space 344, 345 between the piston rods 342, 343 and the interior wall of the cylinder 330 is designated as equal to 1A. The pressure acting on these areas causes the hydrostatic units to stroke toward their maximum displacement position. System pressure is tapped off from the manifold via the same check valves 122 and is fed through modulating valves 128, 130 to the full piston diameter of each of the control pistons 333, 335. The area of face of the pistons 333, 335 is twice the diameter of the spaces 345, or 2A. When system pressure acts on this 1A diameter, the force generated overcomes the force generated on the rod area of the control piston by a factor of 2 due its larger area. This causes the hydrostatic units to stroke toward their zero displacement position.

The modulating valves 128, 130 limit the pressure on the full piston area so as to position the hydrostatic unit at a certain commanded displacement. These modulating valves 128, 130 may be in the form of leader/follower type spool valves, as shown in the schematic of FIGS. 6 and 7, where position feedback is taken from the yoke stroke angle. The modulating valves 128, 130 can then be controlled by solenoid valve or electo-proportional valves 132, 134 to give an electronic control over the displacement of the right and left hydrostatic units 90, 92. There may be an electronic position sensor connected to each of the yokes to give an electronic feed back signal of the hydrostatic unit displacements in order to achieve a closed loop control system.

As the control cylinder is rigidly connected to the manifold, any control forces induced by the hydrostatic units are reacted back directly to the hydrostatic unit assembly, thereby eliminating any hydrostatic unit induced control loads being transmitted to the differential housing structure. This reduces the structural requirements and hence the size and weight of the differential housing.

It would be desirable for the response time of the differential to be very fast to minimize the lag between detection of a condition requiring application of differential torque to the wheels, and actual application of that differential torque. The response time can be made very fast (on the order of 60 ms or less) by keeping the system pressure high. A high system pressure can be maintained by continually stroking the hydrostatic units to a small enough displacement so that the reaction torque on the hydrostatic units will generate a high pressure (in the region of 2000 psi) for any given torque throughput, thereby assuring that there is always enough control force to give a very fast response time.

System pressure could be measured with a sensor, or it is also possible to calculate the system pressure by measuring input speed, output speed and throttle position and then comparing these values against a look up table in the computer, and then stoking the hydrostatic units to a corresponding displacement, all at very high speed.

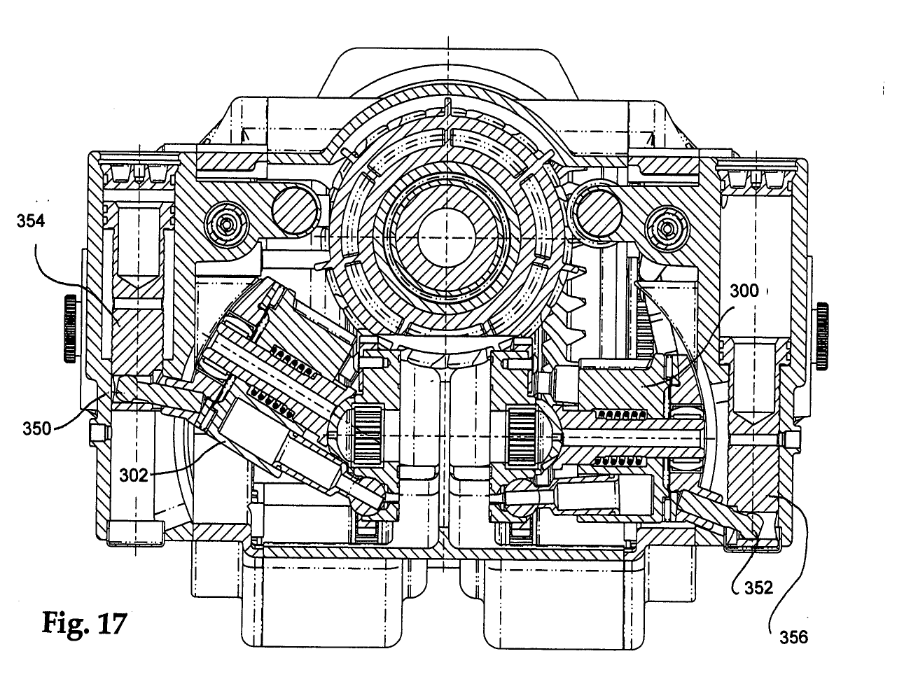

As shown in FIG. 17, the yoke support of the cylinder blocks may be replace with a sliding support in which the cylinder blocks are supported in a cylindrical recess in the differential housing. The displacement control in this case is by way of spherical-headed pins 350, 352 mounted in control pistons 354, 356 in control cylinders in the housing. The structure and operation is otherwise the same. The housing in this embodiment must be made stronger to react the tensile forces exerted by the cylinder blocks 300, 302, but the packaging may be preferable for the particular application.

Obviously, numerous modifications and variations of the preferred embodiment described above are possible and will become apparent to those skilled in the art in light of this specification. Moreover, many functions and advantages are described for the preferred embodiment, but in many uses of the invention, not all of these functions and advantages would be needed. Therefore, we contemplate the use of the invention using fewer than the complete set of noted features, process steps, benefits, functions and advantages. Moreover, several species and embodiments of the invention are disclosed herein, but not all are specifically claimed, although all are covered by generic claims. Nevertheless, it is our intention that each and every one of these species and embodiments, and the equivalents thereof, be encompassed and protected within the scope of the following claims, and no dedication to the public is intended by virtue of the lack of claims specific to any individual species. Accordingly, it is expressly intended that all these embodiments, species, modifications and variations, and the equivalents thereof, in all their combinations, are to be considered within the spirit and scope of the invention as defined in the following claims, wherein we claim:

1. A torque vectoring differential for a vehicle, comprising:
an input bevel gear having a torque drive connection from a drive shaft of said vehicle for driving a transverse shaft;
said transverse shaft having right and left opposite ends, each of which is each coupled to and drives a ring gear of a respective right and left epicyclic gear set;
each of said right and left epicyclic gear set has a planet carrier coupled to a respective right or left wheel axle;
each of said right and left epicyclic gear set has a sun gear meshing with a torque plate of a respective right or left rotating bent-axis hydrostatic unit;
said hydrostatic units each having a displacement control for controlling the hydraulic displacement of said units;
a manifold between said hydrostatic units through which said hydrostatic units are hydraulically coupled;
whereby said differential operates like a conventional open differential in normal driving when said displacement of both hydrostatic units is setting equal, and torque biasing is achieved by setting said displacement of said hydrostatic units at differential displacements, wherein precise distribution of torque between the two wheels is determined by the relative displacement of said two hydrostatic units.

2. A torque vectoring differential as defined in claim 1, further comprising:
an electrical connection from said displacement control and a computer control system which determines a desired torque distribution between the two wheels controls based on inputs from sensors in said vehicle that detects incipient loss of wheel traction.

3. A torque vectoring differential for a vehicle, comprising:
two epicyclic gear sets, each having a first gear element coupled to an input drive shaft for power input from a prime mover of said vehicle;
two variable displacement hydrostatic units, each coupled to a second gear element of one each of said epicyclic gear sets;
an output shaft coupled to a third gear element of each of said epicyclic gear sets;
said hydrostatic units being hydraulically coupled so that hydraulic fluid pressurized in one hydrostatic unit drives the other hydrostatic unit, and fluid pressurized in the other hydrostatic unit drives the one hydrostatic unit; and
a control system for controlling the displacement of said variable displacement hydrostatic units;
whereby, power from said prime mover flows primarily through said epicyclic gear sets to said output shafts, and only differential power is passed through said hydrostatic units, thereby isolating said hydraulic units from said primary power flow and making use of low displacement hydrostatic units possible for said differential power flow through said differential.

4. A torque vectoring differential as defined in claim 3, wherein:
said torque biasing differential is a center differential between front and rear axles of said vehicle; and
said first gear element of said epicyclic gear sets is a planet carrier, and said third gear element of said epicyclic gear sets is a ring gear.

5. A torque vectoring differential as defined in claim 3, wherein:
said torque biasing differential is an axle differential for a front or rear axle of said vehicle; and
said third gear element of said epicyclic gear sets is a planet carrier, and said first gear element of said epicyclic gear sets is a ring gear.

6. A hydromechanical torque vectoring differential, comprising:
a geartrain, including an epicyclic gearset, coupled between an input drive shaft and two output drive shafts, and also coupled to two variable displacement hydrostatic units that are hydraulically coupled together through flow channels, said gear train being configured such that said hydrostatic units react a ratio of the input torque and rotate and cause fluid flow only when there is a differential wheel speed;
whereby, only differential shaft speed power is transmitted to the hydrostatic units.

7. A hydromechanical torque vectoring differential as defined in claim 6, wherein:
said geartrain is configured such that, when both of the hydrostatic units are adjusted to equal displacement, the differential functions as a normally open differential sending equal torque to both wheels, and when both wheels are turning at the same speed, as in a straight ahead condition, there is no flow between the hydrostatic units; and
when one wheel turns faster than the other, as in cornering for example, fluid flows between said hydrostatic units. As one wheel speeds up, the flow from its hydrostatic unit will cause the other hydrostatic unit to rotate in the opposite direction at the same speed and therefore slow the other wheel by the same amount as the first wheel has increased in speed.

8. A hydromechanical torque vectoring differential as defined in claim 6, wherein:
said geartrain is configured such that torque reacted by said hydrostatic units is a small ratio of input torque, thereby enabling use of reduced size hydrostatic units whilst keeping the operating pressure to within acceptable limits.

9. A hydromechanical torque vectoring differential as defined in claim 6, wherein:
said geartrain further includes an input bevel gear attached to an input shaft, and an output bevel gear geared to said input bevel gear at a gear ratio and coupled to both of said epicyclic gearsets, and wherein said epicyclic gearsets offer a ratio of speed reduction and torque multiplication from said output bevel gear to said output shafts;
whereby said gear ratio of said bevel gears is reduced by the same ratio as said epicyclic gearsets to retain the same overall ratio of said differential, thereby reduction of the amount of torque multiplication required by the input bevel gear, and therefore reducing the size of the bevel gearset itself as well as its supporting bearings.

10. A hydromechanical torque vectoring differential as defined in claim 6, further comprising:
a valve in said flow channels for controlling flow between said two hydrostatic units;
whereby, blocking flow between said hydrostatic units locks rotation of the two hydrostatic units and therefore causes both wheels to rotate at the same speed regardless of the torque reacted by the wheels, such that said differential acts as a locked differential.

11. A hydromechanical torque vectoring differential as defined in claim 6, further comprising:
a valve in said flow channels for controlling flow between said two hydrostatic units;
whereby, modulating flow between said hydrostatic units limits the speed difference between said two hydrostatic units and hence the wheels, regardless of the torque reacted by the wheels, causing said differential to act as a limited slip differential.

12. A hydromechanical torque vectoring differential as defined in claim 6, wherein said hydrostatic units each include:
a cylinder block having axial cylinders and pistons mounted in said cylinders, said pistons having hollow piston rods protruding from one end of said cylinders;
a torque plate supported in torque plate bearings for rotation about a central torque plate axis, said torque plate having one face in rotating sliding engagement with a hydraulic manifold having said flow channels opening in flow ports therein for conducting flow of fluid to and from said cylinders, and having an opposite face engaged with said protruding ends of said piston rods in alignment with openings through said torque plate for transfer of said fluid to and from said cylinders and said manifold, by way of said hollow piston rods and said torque plate openings;
said cylinder block having a cylinder block axis of rotation that is adjustable with respect to said torque plate axis for changing displacement of said hydrostatic unit;
a spur gear coaxially attached to said torque plate and in gear mesh with a torque transfer gear for input or output of torque to or from said hydrostatic unit;
said gear mesh being orientated such that radial force exerted by said torque transfer gear partially offsets and reduces radial loads exerted on said torque plate from said pistons.

13. A hydromechanical torque vectoring differential as defined in claim 12, wherein:
said hydrostatic units are in a series configuration, such that said torque plates and hence said flow ports directly opposed on opposite sides of said manifold, such that flow from one hydrostatic unit flows directly through said flow channels to the other hydrostatic unit.

14. A hydromechanical torque vectoring differential as defined in claim 6, further comprising:
a cylinder block for each hydrostatic unit having axial cylinders and pistons mounted in said cylinders, said pistons having hollow piston rods protruding from one end of said cylinders;
a torque plate for each hydrostatic unit supported in torque plate bearings for rotation about a central torque plate axis, said torque plate having one face in rotating sliding engagement with a single hydraulic manifold disposed between said torque plates of said hydrostatic units and having said flow channels opening in flow ports therein for conducting flow of fluid to and from said cylinders, said torque plate having an opposite face engaged with said protruding ends of said piston rods in alignment with openings through said torque plate for transfer of said fluid to and from said cylinders and said manifold, by way of said hollow piston rods and said torque plate openings;
each said cylinder block having a cylinder block axis of rotation, the angle of said cylinder block axis being adjustable with respect to said torque plate axis for changing displacement of said hydrostatic unit;
said hydrostatic units are in a series configuration on opposite sides of said manifold, such that said torque plates and hence said flow ports are directly opposed on opposite sides of said manifold, such that flow from one hydrostatic unit flows directly through said flow channels to the other hydrostatic unit
a valve in said manifold for controlling fluid flow in said flow channels between said two hydrostatic units;
whereby, said valve is operated to modulate or block flow between said hydrostatic units to limit or eliminate the speed difference between said two hydrostatic units and hence said output shafts, regardless of the torque reacted by the output shafts, causing said differential to act as a limited slip or locked differential.

15. A hydromechanical torque vectoring differential as defined in claim 14, further comprising:
a displacement control system for said hydrostatic units, including pistons linked to said cylinders and movable axially in bores under hydraulic pressure controlled by remotely controlled proportional valves to change said cylinder block angles.

16. A hydromechanical torque vectoring differential as defined in claim 15, further comprising:
check valves for tapping system pressure from said hydrostatic units, and fluid flow lines for feeding said system pressure continually to a small area of said pistons for actuating said pistons; and
a modulating valve for feeding said system pressure to a large area of said pistons.

17. A hydromechanical torque vectoring differential as defined in claim 16, wherein:
said check are connected to high and low pressure ports of both hydrostatic units to tap off from the highest pressure from either of the hydrostatic units regardless of whether said valve is actuated or not.

18. A hydromechanical torque vectoring differential as defined in claim 16, wherein:
said modulating valve is of a leader/follower type whereby a signal source actuates said valve, and
a position feedback sensor is located adjacent said displacement control system pistons to provide feedback to said traction control system of said hydrostatic unit displacements.

19. A hydromechanical torque vectoring differential as defined in claim 14, further comprising:
a series of make-up fluid check valves for feeding make-up fluid under low pressure from an external source to said hydrostatic units to make up for fluid lost from leakage;
said make-up fluid check valves are connected to high and low pressure ports of both hydrostatic units feed make-up fluid to the lowest pressure side of each of said hydrostatic units regardless of whether said valves are actuated or not.

20. A hydromechanical torque vectoring differential as defined in claim 14, further comprising:
two yokes for axially supporting said cylinder blocks, said yokes being mounted to contain axial and radial separating forces from both hydrostatic units within said hydrostatic unit and manifold whereby supporting structures and housing of said differential are isolated from said axial and radial separating forces from both hydrostatic units, and only radial separating forces from the torque plate gear mesh are passed through said support structure and housing.

21. A hydromechanical torque vectoring differential as defined in claim 6, further comprising:
a displacement control system for said hydrostatic units, including pistons linked to said hydrostatic units and movable axially in bores under hydraulic pressure controlled by remotely controlled proportional valves.

22. A hydrostatic unit for operation as a hydraulic pump or for operation as a hydraulic motor, comprising:
a cylinder block having axial cylinders and pistons mounted in said cylinders, said pistons having hollow piston rods protruding from one end of said cylinders;
a torque plate supported in torque plate bearings for rotation about a central torque plate axis, said torque plate having one face in rotating sliding engagement with a hydraulic manifold, and having an opposite face engaged with said protruding ends of said piston rods in alignment with openings through said torque plate for transfer of fluid to and from said cylinders and said manifold, by way of said hollow piston rods and said torque plate openings;
said cylinder block having a cylinder block axis of rotation that is adjustable with respect to said torque plate axis for changing displacement of said hydrostatic unit;
said torque plate having a coaxial spur gear on an outer diameter of said torque plate and in gear mesh with a torque transfer gear for input or output of torque to or from said hydrostatic unit;
said gear mesh being orientated such that radial force exerted by said torque transfer gear partially offsets and reduces radial loads exerted on said torque plate from said pistons.

23. A process for vectoring torque from an input shaft to two output shafts, comprising:
inputting torque from a drive shaft via a pair of bevel gears to input elements of two epicyclic gear sets;
driving two output shafts with output torque from output elements of said two epicyclic gearsets;
reacting said output torque in said epicyclic gearsets via third elements of said epicyclic gearsets to a pair of hydraulically coupled variable displacement hydrostatic units; and
varying the displacements between said two hydrostatic units to vary the torque bias to either output shaft.

24. A process for vectoring torque from an input shaft to two output shafts as defined in claim 23, further comprising:
adjusting both hydrostatic units to equal displacement to produce an equal torque bias of 50% to each output shaft;
then adjusting the displacement of said hydrostatic units to unequal displacement between full displacement and zero displacement to produce a torque bias that is infinitely variable between 50-50% to 100-0% by varying the relative displacements of said two hydrostatic units.

25. A process for vectoring torque from an input shaft to two output shafts as defined in claim 23, further comprising:
controlling displacement of said hydrostatic units by moving at least one control piston linked to said hydrostatic units under hydraulic pressure controlled by a remotely controlled proportional valve to change said displacement of said hydrostatic units;
minimizing response time of said controlling step by maintaining system pressure to said control at a high pressure.
